(19) United States
(12) Patent Application Publication
(10) Pub. No.: US 2021/0343270 A1
(43) Pub. Date: Nov. 4, 2021

(54) SPEECH TRANSLATION METHOD AND TRANSLATION APPARATUS

(71) Applicant: LANGOGO TECHNOLOGY CO., LTD, Shenzhen (CN)

(72) Inventors: YAN ZHANG, Shenzhen (CN); Tao Xiong, Shenzhen (CN)

(21) Appl. No.: 16/470,560

(22) PCT Filed: Apr. 2, 2019
(86) PCT No.: PCT/CN2019/081036

§ 371 Date: Jun. 18, 2019

(30) Foreign Application Priority Data
Sep. 19, 2018 (CN) 201811094286.9

(51) Int. Cl. G10L 15/00; G10L 15/08

(52) U.S. Cl. CPC G10L 15/005; G10L 15/08

(57) ABSTRACT

There are a speech translation method and a translation apparatus. The method includes: collecting a sound in response to a translation task being triggered, and detecting whether a user starts speaking based on the collected sound; entering a voice recognition state in response to detecting the user having started speaking, extracting a user voice from the collected sound, determining a source language used by the user based on the extracted user voice, and determining a target language associated with the source language based on a preset language pair; exiting the voice recognition state in response to detecting the user having stopped speaking for more than a preset delay duration, and converting the user voice extracted in the voice recognition state into a target voice of the target language; a playing the target voice, and returning to the step of detecting whether the user starts speaking until the translation task ends.

### BACKGROUND

### 1. Technical Field

The present disclosure relates to data processing technology, and particularly to a speech translation method and a translation apparatus.

### 2. Description of Related Art

Simultaneous interpretation, abbreviated as “SI”, and also known as “simultaneous translation” and “synchronous interpretation”, which refers to a translation method in which a translator continuously translates contents to the audience without interrupting the speaker's speech. Simultaneous interpreters provide instant translation through dedicated equipment, which is suitable for large seminars and international conferences, and is usually performed in turn by two to three translators. At present, simultaneous interpretation mainly relies on translators to listen and then translate and pronounce. With the development of AI (artificial intelligence) technology, AI simultaneous interpretation will gradually replace artificial translation. Although there are some conference interpreters in the market, it is necessary to prepare a translation apparatus for each person for performing the translation, hence have a high cost. In addition, the speaker usually needs to hold down the button to start speaking, and then the online translation customer service personnel (i.e., the translator) translates the speaker's words to others, which is cumbersome in operations, and requires more manual participation.

### SUMMARY

The embodiments of the present disclosure provide a speech translation method and a translation apparatus, which are capable of reducing translation cost and simplifying translation operations.

Among the embodiments of the present disclosure, a speech translation method applied to a translation apparatus including a processor as well as a sound collecting device and a sound playback device which are electrically coupled to the processor is provided. The method includes:

collecting a sound in an environment through the sound collecting device in response to a translation task being triggered, and detecting whether a user starts speaking based on the collected sound through the processor;

entering a voice recognition state in response to detecting the user having started speaking, extracting a user voice from the collected sound through the processor, determining a source language used by the user based on the extracted user voice, and determining a target language associated with the source language based on a preset language pair;

exiting the voice recognition state in response to detecting the user having stopped speaking for more than .a preset delay duration, and converting the user voice extracted in the voice recognition state into a target voice of the target language through the processor; and

playing the target voice through the sound playback device, and returning to the step of detecting whether the user starts speaking based on the collected sound through the processor until the translation task ends.

Among the embodiments of the present disclosure, a translation apparatus is further provided. The apparatus includes:

an end point detecting module configured to collect a sound in an environment through the sound collecting device in response to a translation task being triggered, and detect whether a user starts speaking based on the collected sound;

a recognition module configured to enter a voice recognition state in response to detecting the user having started speaking, extract a user voice from the collected sound, determine a source language used by the user based on the extracted user voice, and determining a target language associated with the source language based on a preset language pair;

a tail point detecting module configured to detect whether the user has stopped speaking for more than a preset delay duration, and exit the voice recognition state in response to detecting the user having stopped speaking for more than the preset delay duration;

a translation and voice synthesizing module configured to convert the user voice extracted in the voice recognition state into a target voice of the target language through the processor; and

a playback module configured to play the target voice through the sound playback device, and trigger the end point detecting module to execute the step of detecting whether the user starts speaking based on the collected sound.

Among the embodiments of the present disclosure, a translation apparatus is further provided. The apparatus includes: a sound collecting device, a sound playback device, a storage, a processor, and a computer program stored in the storage and executable on the processor; where, the sound collecting device, the sound playback device, and the storage are electrically coupled to the processor; when the processor executes the computer program, the following steps are executed:

collecting a sound in an environment through the sound collecting device in response to a translation task being triggered, and detecting whether a user starts speaking based on the collected sound; entering a voice recognition state in response to detecting the user having started speaking, extracting a user voice from the collected sound, determining a source language used by the user based on the extracted user voice, and determining a target language associated with the source language based on a preset language pair; exiting the voice recognition state in response to detecting the user having stopped speaking for more than a preset delay duration, and converting the user voice extracted in the voice recognition state into a target voice of the target language; and playing the target voice through the sound playback device, and returning to the step of detecting whether the user starts speaking based on the collected sound until the translation task ends.

In each of the above-mentioned embodiments, during the execution of the translation task, it automatically takes loops to monitor whether the user starts or ends speaking, and translates the words spoken by the user into the target language to play out. On the one hand, it realizes the simultaneous translation for multiple people in one translation apparatus, thereby reducing translation costs. On the other hand, it really realizes the automatic detecting, translation and playback of the content of the conversation of the user on the translation apparatus, thereby simplifying the translation operations.

### BRIEF DESCRIPTION OF THE DRAWINGS

FIG. 1 is a flow chart of an embodiment of a speech translation method according to the present disclosure.

FIG. 2 is a flow chart of another embodiment of a speech translation method according to the present disclosure.

FIG. 3 is a schematic diagram of an example of the practical application of the speech translation method according to an embodiment of the present disclosure.

FIG. 4 is a schematic structural diagram of an embodiment of a translation apparatus according to the present disclosure.

FIG. 5 is a schematic structural diagram of another embodiment of a translation apparatus according to the present disclosure.

FIG. 6 is a schematic structural diagram of the hardware of an embodiment of a translation apparatus according to the present disclosure.

FIG. 7 is a schematic structural diagram of the hardware of another embodiment of a translation apparatus according to the present disclosure.

### DETAILED DESCRIPTION

In order to make the object, the features and the advantages of the present disclosure more obvious and easy to understand, the technical solutions in the embodiments of the present disclosure will be clearly and completely described below in conjunction with the drawings in the embodiments of the present disclosure. Apparently, the following embodiments are only part of the embodiments of the present disclosure, not all of the embodiments of the present disclosure. All other embodiments obtained based on the embodiments of the present disclosure by those skilled in the art without creative efforts are within the scope of the present disclosure.

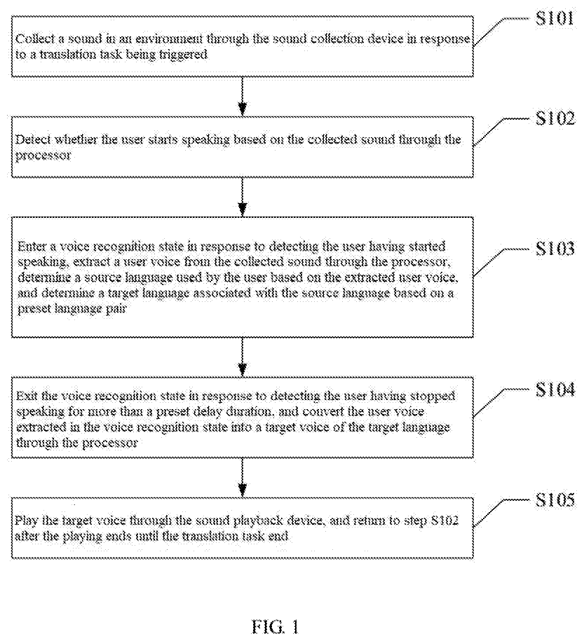

Please refer to FIG. 1, which is a flow chart of an embodiment of a speech translation method according to the present disclosure. The speech translation method is applied to a translation apparatus including a processor as well as a sound collecting device and a sound playback device which are electrically coupled to the processor. In which, the sound collecting device can be, for example, a microphone or a pickup, and the sound playback device can be, for example, a speaker. As shown in FIG. 1, the speech translation method includes:

S101: collecting a sound in an environment through the sound collecting device in response to a translation task being triggered.

S102: detecting whether the user starts speaking based on the collected sound through the processor.

The translation task can be but not limited to be automatically triggered after the translation apparatus is activated, be triggered in response to a click operation by the user on a preset button for triggering the translation task being detected, or be triggered in response to a preset first voice of the user being detected. In which, the button can be a hardware button or a virtual button. The preset first voice may be set based on a customized operation of the user, for example, a voice containing the semantics of “start translation” or other preset voices.

When the translation task is triggered, the sound in the environment is collected through the sound collecting device in real time, and it analyzes that whether the collected sound includes human voice through the processor in the real-time. If human voice is included, it is confirmed that the user starts to speak.

Optionally, if the collected sound still does not include human voice while a preset detection duration is exceeded, the sound collection is stopped to enter a standby state so as to reduce the power consumption.

S103: entering a voice recognition state in response to detecting the user having started speaking, extracting a user voice from the collected sound through the processor, determining a source language used by the user based on the extracted user voice, and determining a target language associated with the source language based on a preset language pair.

The translation apparatus stores with an association relationship between at least two languages included in the preset language pair. The language pair can be used to determine the source language and the target language. When it is detected that the user starts speaking, the voice recognition state is entered, the user voice is extracted from the collected sound through the processor, and a voice recognition is performed on the extracted user voice to determine the source language used by the user. According to the above-mentioned association relationship, other language associated with the source language in the language pair is determined as the target language.

Optionally, in another embodiment of the present disclosure, a language setting interaction interface is provided to the user. Before having detected that the user starts speaking, a language specifying operation performed by the user on the language setting interactive interface will be responded, so as to set at least two languages specified by the language specifying operation as the language pair for determining the source language and the target language.

S104: exiting the voice recognition state in response to detecting the user having stopped speaking for more than a preset delay duration, and converting the user voice extracted in the voice recognition state into a target voice of the target language through the processor.

It analyzes that whether the human voice included in the collected sound disappears through the processor in real time. If the voice disappears, a timer is actuated to start timing, and it confirms to have detected that the user has stopped speaking if the sound not appears again within the preset delay duration, and then exits the voice recognition state. Afterwards, all the user voices extracted in the voice recognition state are converted into the target voice of the target language through the processor.

S105: playing the target voice through the sound playback device, and returning to step S102 after the playing ends until the translation task ends.

The target voice is played through the sound playback device, and then it returns to step S102 after the playing of the target voice ends: it detects whether the user starts speaking based on the collected sound through the processor so as to translate the words spoken by another speaker, and repeats the forgoing process until the translation task ends.

In which, the translation task may be but not limited to: be terminated in response to having detected that the user clicks on a preset button for terminating the translation task or be triggered in response to having detected the second preset voice of the user. In which, the button can be a hardware button or a virtual button. The second preset voice may be set based on a customized operation of the user, for example, a voice containing the semantics of “stop translation” or other voices.

Optionally, the sound collection can be paused during the playback of the target voice to avoid the mis-determination of the user voice while reduce power consumption.

In this embodiment, during the execution of the translation task, it automatically takes loops to monitor whether the user starts or ends speaking, and translates the words spoken by the user into the target language to play out. On the one hand, it realizes the simultaneous translation for multiple people in one translation apparatus, thereby reducing translation costs. On the other hand, it really realizes the automatic detecting, translation and playback of the content of the conversation of the user on the translation apparatus, thereby simplifying the translation operations.

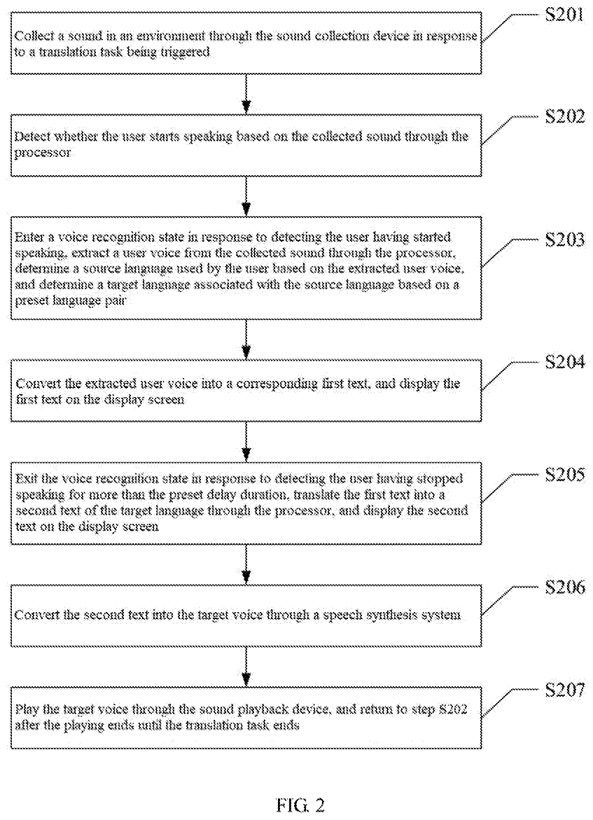

Please refer to FIG. 2, which is a flow chart of another embodiment of a speech translation method according to the present disclosure. The speech translation method is applied to a translation apparatus including a processor as well as a sound collecting device and a sound playback device which are electrically coupled to the processor. In which, the sound collecting device can be, for example, a microphone or a pickup, and the sound playback device can be, for example, a speaker. As shown in FIG. 2, the speech translation method includes:

S201: collecting a sound in an environment through the sound collecting device in response to a translation task being triggered.

S202: detecting whether the user starts speaking based on the collected sound through the processor.

The translation task can be but not limited to be automatically triggered after the translation apparatus is activated, be triggered in response to a click operation by the user on a preset button for triggering the translation task being detected, or be triggered in response to a preset first voice of the user being detected. In which, the button can be a hardware button or a virtual button. The preset first voice may be set based on a customized operation of the user, for example, a voice containing the semantics of “start translation” or other voices.

When the translation task is triggered, the sound in the environment is collected through the sound collecting device in real time, and it analyzes that whether the collected sound includes human voice through the processor in the real-time. If human voice is included, it is confirmed that the user starts to speak.

Optionally, in another embodiment of the present disclosure, in order to ensure the translation quality, it periodically checks whether the noise in the environment is greater than the preset noise based on the collected sound through the processor, and outputs prompt information when the noise is greater than the preset noise. The prompt information is for prompting the user that the translation environment is poor. In which, the prompt information can be output in the manner of voice and/or text. Optionally, the noise detection can only be performed before entering the voice recognition state.

Optionally, in another embodiment of the present disclosure, in order to avoid translation errors, when the translation task is triggered, it collects the sound in the environment through the sound collecting device in real time, and analyzes whether the collected sound includes human voice and whether the volume of the included human voice is greater than a preset decibel through the processor in the real-time. If it includes human voice and the volume of the included human voice is greater than the preset decibel, it is confirmed that the user has started to speak.

S203: entering a voice recognition state in response to detecting the user having started speaking, extracting a user voice from the collected sound through the processor, determining a source language used by the user based on the extracted user voice, and determining a target language associated with the source language based on a preset language pair.

The translation apparatus further includes a storage electrically coupled to the processor. The storage stores with an association relationship between at least two languages included in the preset language pair. The language pair can be used to determine the source language and the target language. When it is detected that the user starts speaking, the voice recognition state is entered, the user voice is extracted from the collected sound through the processor, and a voice recognition is performed on the extracted user voice to determine the source language used by the user. According to the above-mentioned association relationship, other language associated with the source language in the language pair is determined as the target language. For example, assuming that the language pair is English and Chinese, if the source language is Chinese, the target language will be English, then it needs to convert the language of the user into Chinese voice; assuming that the language pair is English-Chinese-Russian, if the source language is English, it determines the target language as Chinese and Russian, that is, it needs to convert the language of the user into Chinese voice and Russian voice.

Optionally, in another embodiment of the present disclosure, a language setting interaction interface is provided to the user. Before having detected that the user starts speaking, a language specifying operation performed by the user on the language setting interactive interface will be responded, so as to set at least two languages specified by the language specifying operation as the language pair for determining the source language and the target language.

Optionally, in another embodiment of the present disclosure, the storage further stores with identifier information of each language in the language pair. The identifier information may be generated for each language in the language pair through the processor when the language pair is set. The above-mentioned step of determining the source language used by the user based on the extracted user voice specifically includes: extracting a voiceprint feature of the user in the user voice through the processor, and determining whether identifier information of a language corresponding to the voiceprint feature is stored in the storage; determining a language corresponding to the identifier information as the source language, if the identifier information is stored in the storage; and extracting a pronunciation feature of the user in the user voice, determining the source language based on the pronunciation feature, and storing a correspondence between the voiceprint feature of the user and the identifier information of the source language in the storage for the language recognition at the next translation, if the identifier information is not stored in the storage.

Specifically, the pronunciation feature of the user can be matched with the pronunciation feature of each language in the language pair, and the language with the highest matchingness is determined as the source language. The above-mentioned matching of the pronunciation features can be performed locally on the translation apparatus or be implemented through a server.

In this way, since the pronunciation feature comparison needs to occupy more system resources, by automatically recording the correspondence between the voiceprint feature of the user and the identifier information of the source language and using the voiceprint feature of the user and the above-mentioned correspondence to determine the source language, the efficiency of the language recognition can be improved.

S204: converting the extracted user voice into a corresponding first text, and displaying the first text on the display screen.

In which, the language of the first text is the source language.

S205: exiting the voice recognition state in response to detecting the user having stopped speaking for more than the preset delay duration, translating the first text into a second text of the target language through the processor, and displaying the second text on the display screen;

S206: converting the second text into the target voice through a speech synthesis system.

Specifically, the translation apparatus further includes a display screen electrically coupled to the processor. It analyzes that whether the human voice included in the collected sound disappears through the processor in real time. If the voice disappears, a timer is actuated to start timing, and it confirms to have detected that the user has stopped speaking if the sound not appears again within the preset delay duration, and then exits the voice recognition state. Afterwards, the first text of the source language corresponding to the user voice extracted in the voice recognition state is translated into the second text of the target language through the processor, and the second text is displayed on the display screen. At the same time, the second text is converted into the target voice of the target language through a TTS (text to speech) speech synthesizing system.

Optionally, in another embodiment of the present disclosure, if it is detected that the user has stopped speaking for more than the preset delay duration, before exiting the voice recognition state, it exits the voice recognition state in response to the triggered translation instruction. The preset delay duration is adjusted based on a time difference between a time of having detected that the user has stopped speaking and a time of the translation instruction being triggered. For example, the value of the time difference can be set to the value of the preset delay duration.

Optionally, in another embodiment of the present disclosure, the translation apparatus further includes a motion sensor electrically coupled to the processor. In the voice recognition state, the translation instruction is triggered in response to the motion sensor having detected that the motion amplitude of the translation apparatus is greater than a preset amplitude or the translation apparatus has been collided.

Since the initial value of the preset delay duration is a default value while each speaker's patience is different, it allows the user to actively trigger the translation instruction by passing the translation apparatus or colliding the translation apparatus, and dynamically adjusts the preset delay duration based on the triggered time of the translation instruction, thereby improving the flexibility in determining whether the user has stopped speaking or not, so that the timing of the translation can be more in line with the needs of the user.

Optionally, in another embodiment of the present disclosure, the step of adjusting the preset delay duration based on the time difference between the time of having detected the user having stopped speaking and the time of the translation instruction being triggered specifically includes: determining whether the preset delay duration corresponding to the voiceprint feature of the user who has stopped speaking is stored in the storage; adjusting the preset delay duration corresponding to the voiceprint feature of the user based on the time difference between the time of having detected that the user has stopped speaking and the time of the translation instruction being triggered, if the corresponding preset delay duration is stored in the storage; and setting the time difference as the preset delay duration corresponding to the voiceprint feature of the user, if the corresponding preset delay duration is not stored in the storage, that is, only a default delay duration for triggering the exit of the voice recognition state is set. Through the above-mentioned steps, different preset delay durations can be set for different speakers, thereby improving the intelligence of the translation apparatus.

Optionally, the adjusting the preset delay duration based on the time difference includes setting the value of the time difference as the preset delay duration, or taking an average of the time difference and the preset delay duration as the new value of the preset delay duration.

S207: playing the target voice through the sound playback device, and returning to step S202 after the playing ends until the translation task ends.

The target voice is played through the sound playback device, and then it returns to step S102 after the playing of the target voice ends: it detects whether the user starts speaking based on the collected sound through the processor so as to translate the words spoken by another speaker, and repeats the forgoing process until the translation task ends.

In which, the translation task may be but not limited to: be terminated in response to having detected that the user clicks on a preset button for terminating the translation task or be triggered in response to having detected the second preset voice of the user. In which, the button can be a hardware button or a virtual button. The second preset voice may be set based on a customized operation of the user, for example, a voice containing the semantics of “stop translation” or other voices.

Optionally, the sound collection can be paused during the playback of the target voice to avoid the mis-determination of the user voice while reduce power consumption.

Optionally, in another embodiment of the present disclosure, all the first text and the second text obtained during the execution of the translation task may be stored in a storage as a conversation record, so as to facilitate subsequent query by the user. At the same time, the processor cleans up the conversation record which exceeds the storage period periodically or automatically after each boot, so as to improve the utilization of the storage space.

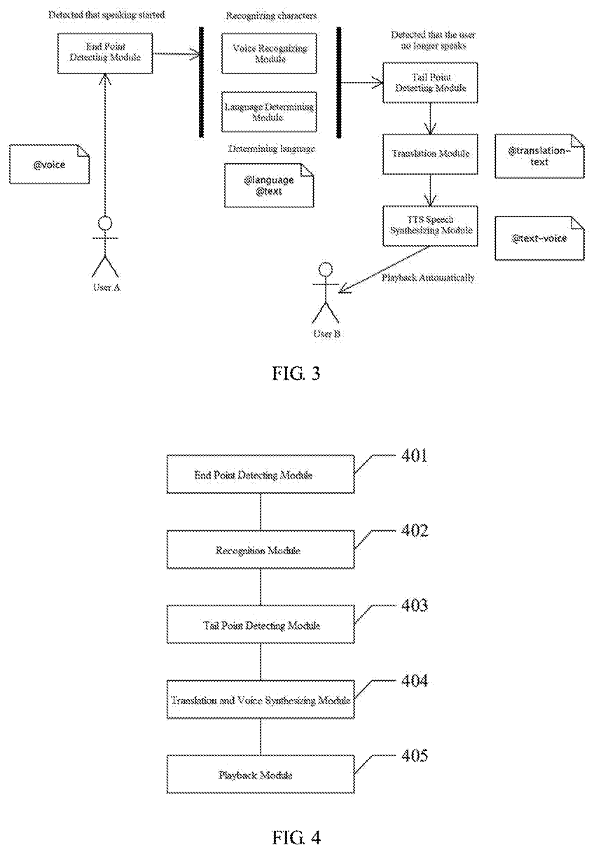

In order to further describe the speech translation method provided by this embodiment, with reference to FIG. 3, for example, assuming that user A and user B are people of different countries, user A uses language A, and user B uses language B, the translation can be achieved by the following steps:

1. user A speaks to generate voice A;

2. automatically detect that user A has started speaking through an end point detection module of the above-mentioned translation apparatus;

3. recognize the words spoken by the user A while determines the language used by the user A (i.e., the language type) through a voice recognizing module and a language determining module of the translation apparatus;

4. the language determining module detects that what user A speaks language A, and the first text corresponding to the currently recognized voice A is displayed on the display screen of the translation apparatus;

5. the translation apparatus automatically determines that the user has finished speaking through the tail point detection module if user A stops speaking;

6. at this time, the translation apparatus will enter a translation stage, and convert the first text of language A into the second text of language B through the translation module;

7. the translation apparatus generates the corresponding target speech through a TTS speech synthesizing module and plays out automatically, after the translation apparatus obtains the second text of language B.

Thereafter, the translation apparatus automatically detects that user B has started speaking again through the end point detecting module, then the above-mentioned steps 3-7 are performed based on user B to translate the voice of language B of user B into the target voice of language A and play out automatically, and then the forgoing process is repeated until the conversation between user A and B ends.

During the entire translation process, user A does not need to perform additional operations on the translation apparatus, and the translation apparatus will perform a series of processes of listening, recognizing, ending, translating, playing, and the like.

Optionally, in another embodiment of the present disclosure, in order to improve the speed of the language recognition, the voiceprint feature of the user can be collected in advance in the first use, and the collected voiceprint feature can be bound to the language used by the user. In the second use, the language used by the user can be quickly confirmed based on the voiceprint feature of the user.

Specifically, the translation apparatus provides the user with an interface for binding the voiceprint feature and the corresponding language. Before triggering the translation task, in response to a binding instruction triggered by the user through the interface, the target voice of the user is collected through the sound collecting device, and a voice recognition is performed on the target voice to obtain the voiceprint feature of the user and the language used by the user, and then the recognized voiceprint feature of the user and the used language are bounded in the translation apparatus. Alternatively, the language bound to the voiceprint feature can also be a language that the binding instruction points to.

Then, if the user is detected as having started speaking, it enters the voice recognition state, and extracts the user voice from the collected sound through the processor, and determines the source language used by the user based on the extracted user voice, which specifically includes: entering the voice recognition state in response to having detected that the user starts speaking, extracting the user voice from the collected sound through the processor, and performing the voiceprint recognition on the extracted user voice to obtain the voiceprint feature of the user and the language bounded by the voiceprint feature, and then taking the language as the source language used by the user.

For example, assuming that user A uses language A and user B uses language B, before performing translation, user A and user B respectively bind their voiceprint features and the languages to be used in the translation apparatus through the interface provided by the translation apparatus. For example, user A and the user B sequentially trigger the binding instruction by pressing a language setting button of the translation apparatus, and record a voice in the translation apparatus according to the prompt information output by the translation apparatus. In which, the prompt information can be output in the manner of voice or text. The voice setting button can be a physical button or a virtual button.

The translation apparatus performs the voice recognition on the recorded voices of user A and user B, obtains the voiceprint feature of user A and its corresponding language A, and associates the obtained voiceprint feature of user A with its corresponding language A, and then stores the association information in the storage to bind the voiceprint feature of user A and its corresponding language A in the translation apparatus; similarly, which obtains the voiceprint feature of user B and its corresponding language B, and associates the obtained voiceprint feature of user B with its corresponding language B, and then stores the information of the association in the storage to bind the voiceprint feature of user B and its corresponding language B in the translation apparatus.

After the translation task is triggered, when it detects that user A has started to speak, the language used by user A can be confirmed through the voiceprint recognition based on the above-mentioned association information. At this time, the language recognition is no longer needed. In comparison with the language recognition, the voiceprint recognition has lower computational complexity and less system resource consumptions, hence the recognition speed can be improved, thereby improving the translation speed.

In this embodiment, during the execution of the translation task, it automatically takes loops to monitor whether the user starts or ends speaking, and translates the words spoken by the user into the target language to play out. On the one hand, it realizes the simultaneous translation for multiple people in one translation apparatus, thereby reducing translation costs. On the other hand, it really realizes the automatic detecting, translation and playback of the content of the conversation of the user on the translation apparatus, thereby simplifying the translation operations.

Please refer to FIG. 4, which is a schematic structural diagram of an embodiment of a translation apparatus according to the present disclosure. The translation apparatus can be used to implement the speech translation method shown in FIG. 1. The translation apparatus includes an end point detecting module 401, a recognition module 402, a tail point detecting module 403, a translation and voice synthesizing module 404, and a playback module 405.

The end point detecting module 401 is configured to collect a sound in an environment through the sound collecting device in response to a translation task being triggered, and detect whether a user starts speaking based on the collected sound.

The recognition module 402 is configured to enter a voice recognition state in response to detecting the user having started speaking, extract a user voice from the collected sound, determine a source language used by the user based on the extracted user voice, and determining a target language associated with the source language based on a preset language pair.

The tail point detecting module 403 is configured to detect whether the user has stopped speaking for more than a preset delay duration, and exit the voice recognition state in response to detecting the user having stopped speaking for more than the preset delay duration.

The translation and voice synthesizing module 404 is configured to convert the user voice extracted in the voice recognition state into a target voice of the target language through the processor.

The playback module 405 is configured to play the target voice through the sound playback device, and trigger the end point detecting module to execute the step of detecting whether the user starts speaking based on the collected sound.

Furthermore, as shown in FIG. 5, in another embodiment of the present disclosure, the translation apparatus further includes:

a noise estimating module 501 configured to detect whether a noise in the environment is greater than a preset noise based on the collected sound, and output prompt information for prompting the user that the environment is unsuitable for translations if the noise is greater than the preset noise.

Furthermore, the translation apparatus further includes:

a setting module 502 configured to set at least two languages specified by a language specifying operation as the language pair, in response to the language specifying operation of the user.

Furthermore, the recognition module 402 is further configured to convert the extracted user voice into a corresponding first text.

Furthermore, the translation apparatus further includes:

A display module 503 configured to display the first text on the display screen.

Furthermore, the translation and voice synthesizing module 404 is further configured to translate the first text into a second text of the target language, and convert the second text into the target voice through a speech synthesis system.

The display module 503 is further configured to display the second text on the display screen.

Furthermore, the translation apparatus further includes:

a processing module 504 configured to exit the voice recognition state in response to a translation instruction being triggered.

The setting module 502 is further configured to adjust the preset delay duration based on a time difference between a time of having detected the user having stopped speaking and a time of the translation instruction being triggered.

Furthermore, the processing module 504 is further configured to trigger the translation instruction in the voice recognition state, when a motion amplitude of the translation apparatus detected through the motion sensors is greater than a preset amplitude or the translation apparatus is collided.

Furthermore, the recognition module 402 is further configured to extract a voiceprint feature of the user in the user voice, and determine whether identifier information of a language corresponding to the voiceprint feature is stored in the storage; determine a language corresponding to the identifier information as the source language, if the identifier information is stored in the storage; and extract a pronunciation feature of the user in the user voice, determine the source language based on the pronunciation feature, and store a correspondence between the voiceprint feature of the user and the identifier information of the source language in the storage, if the identifier information is not stored in the storage.

Furthermore, the configuration module 502 is further configured to determine whether the preset delay duration corresponding to the voiceprint feature of the user having stopped speaking is stored in the storage; adjusting the corresponding preset delay duration based on the time difference between the time of having detected the user having stopped speaking and the time of the translation instruction being triggered, if the corresponding preset delay duration is stored in the storage; and setting the time difference as the corresponding preset delay duration, if the corresponding preset delay duration is not stored in the storage.

Furthermore, the processing module 504 is further configured to store all the first text and the second text obtained during the execution of the translation task in a storage as a conversation record, so as to facilitate subsequent query by the user.

The processing module 504 is further configured to clean up the conversation record which exceeds the storage period periodically or automatically after each boot, so as to improve the utilization of the storage space.

Furthermore, the recognition module 402 is further configured to respond to a binding instruction triggered by the user, collect the target voice of the user through the sound collecting device, and perform a voice recognition on the target voice to obtain the voiceprint feature of the user and the language used by the user

The configuration module 502 is further configured to bind the recognized voiceprint feature of the user and the used language in the translation apparatus.

The recognition module 402 is further configured to enter the voice recognition state in response to having detected that the user starts speaking, extract the user voice from the collected sound, and perform the voiceprint recognition on the extracted user voice to obtain the voiceprint feature of the user and the language bounded by the voiceprint feature, and then take the language as the source language used by the user.

For the specific process of implementing the respective functions of the above-mentioned modules, it may refer to the related content in the embodiments shown in FIG. 1-FIG. 3, which is not described herein.

In this embodiment, during the execution of the translation task, it automatically takes loops to monitor whether the user starts or ends speaking, and translates the words spoken by the user into the target language to play out. On the one hand, it realizes the simultaneous translation for multiple people in one translation apparatus, thereby reducing translation costs. On the other hand, it really realizes the automatic detecting, translation and playback of the content of the conversation of the user on the translation apparatus, thereby simplifying the translation operations.

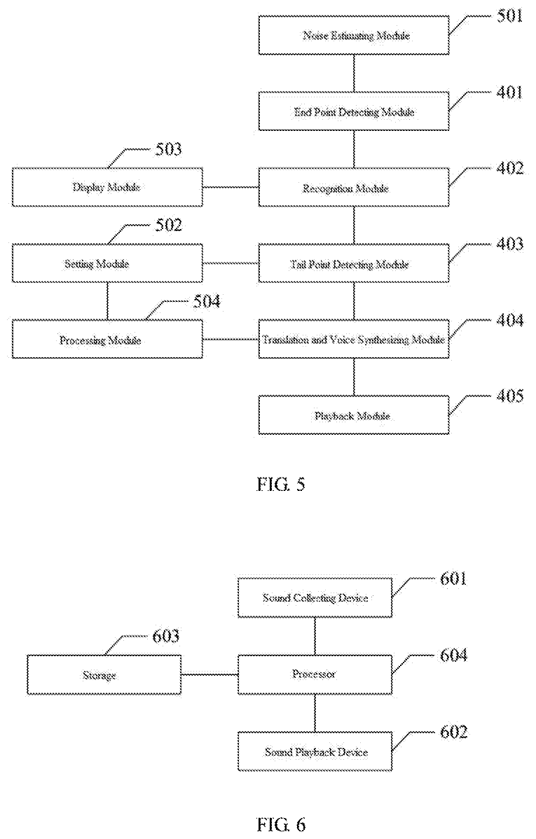

Please refer to FIG. 6, which is a schematic structural diagram of the hardware of an embodiment of a translation apparatus according to the present disclosure.

The translation apparatus described in this embodiment includes a sound collecting device 601, a sound playback device 602, a storage 603, a processor 604, and a computer program stored in the storage 603 and executable in the processor 604.

In which, the sound collecting device 601, the sound playback device 602, and the storage 603 are electrically coupled to the processor 604. The storage 603 may be a high speed random access memory (RAM) or a non-volatile memory such as a magnetic disk. The storage 603 is for storing a set of executable program codes.

When the processor 604 executes the computer program, the following steps are executed:

collecting a sound in an environment through the sound collecting device 601 in response to a translation task being triggered, and detecting whether a user starts speaking based on the collected sound; entering a voice recognition state in response to detecting the user having started speaking, extracting a user voice from the collected sound, determining a source language used by the user based on the extracted user voice, and determining a target language associated with the source language based on a preset language pair; exiting the voice recognition state in response to detecting the user having stopped speaking for more than a preset delay duration, and converting the user voice extracted in the voice recognition state into a target voice of the target language; and playing the target voice through the sound playback device 602, and returning to the step of detecting whether the user starts speaking based on the collected sound until the translation task ends.

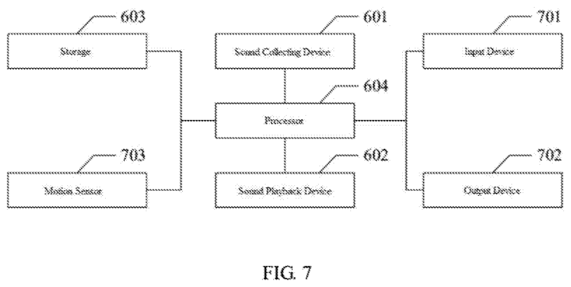

Furthermore, as shown in FIG. 7, in another embodiment of this embodiment, the translation apparatus further includes:

at least one input device 701, at least one output device 702, and at least one motion sensor 703 which are electrically coupled to the processor 604. In which, the input device 701 may specifically be a camera, a touch panel, a physical button, or the like. The output device 702 may specifically be a display screen. The motion sensor 703 may specifically be a gravity sensor, a gyroscope, an acceleration sensor, or the like.

Furthermore, the translation apparatus further includes a signal transceiver for receiving and transmitting wireless network signals.

For the specific process of implementing the respective functions of the above-mentioned components, it may refer to the related content in the embodiments shown in FIG. 1-FIG. 3, which is not described herein

In this embodiment, during the execution of the translation task, it automatically takes loops to monitor whether the user starts or ends speaking, and translates the words spoken by the user into the target language to play out. On the one hand, it realizes the simultaneous translation for multiple people in one translation apparatus, thereby reducing translation costs. On the other hand, it really realizes the automatic detecting, translation and playback of the content of the conversation of the user on the translation apparatus, thereby simplifying the translation operations.

In the embodiments provided by the present disclosure, it is to be understood that the disclosed apparatuses and methods can be implemented in other ways. For example, the device embodiments described above are merely illustrative; the division of the modules is merely a division of logical functions, and can be divided in other ways such as combining or integrating multiple modules or components with another system when being implemented; and some features can be ignored or not executed. In another aspect, the coupling such as direct coupling and communication connection which is shown or discussed can be implemented through some interfaces, and the indirect coupling and the communication connection between devices or modules can be electrical, mechanical, or otherwise.

The modules described as separated components can or cannot be physically separate, and the components shown as modules can or cannot be physical modules, that is, can be located in one place or distributed over a plurality of network elements. It is possible to select some or all of the modules in accordance with the actual needs to achieve the object of the embodiments.

In addition, each of the functional modules in each of the embodiments of the present disclosure can be integrated in one processing module. Each module can be physically exists alone, or two or more modules can be integrated in one module. The above-mentioned integrated module can be implemented either in the form of hardware, or in the form of software functional modules.

The integrated module can be stored in a computer-readable storage medium if it is implemented in the form of a software functional module and sold or utilized as a separate product. Based on this understanding, the technical solution of the present disclosure, either essentially or in part, contributes to the prior art, or all or a part of the technical solution can be embodied in the form of a software product. The software product is stored in a readable storage medium, which includes a number of instructions for enabling a computer device (which can be a personal computer, a server, a network device, etc.) to execute all or a part of the steps of the methods described in each of the embodiments of the present disclosure. The above-mentioned storage medium includes a variety of readable storage media such as a USB disk, a mobile hard disk, a read-only memory (ROM), a random access memory (RAM), a magnetic disk, and an optical disk which is capable of storing program codes.

It should be noted that, for the above-mentioned method embodiments, for the convenience of description, they are all described as a series of action combinations. However, those skilled in the art should understand that, the present disclosure is not limited by the described action sequence, because certain steps may be performed in other sequences or concurrently in accordance with the present disclosure. In addition, those skilled in the art should also understand that, the embodiments described in the specification are all preferred embodiments, and the actions and modules involved are not necessarily required by the present disclosure.

In the above-mentioned embodiments, the description of each embodiment has its focuses, and the parts which are not described in one embodiment may refer to the related descriptions in other embodiments.

The forgoing is a description of the speech translation method and the translation apparatus provided by the present disclosure. For those skilled in the art, according to the idea of the embodiment of the present disclosure, there will be changes in the specific implementation manner and the application range. In summary, the contents of the specification should not be comprehended as limitations to the present disclosure.

1. A speech translation method for a speech translation apparatus, wherein the translation apparatus comprising a processor, a sound collecting device electrically coupled to the processor, and a sound playback device electrically coupled to the processor; wherein the method comprises:
collecting a sound in an environment through the sound collecting device in response to a translation task being triggered, and detecting whether a user starts speaking based on the collected sound through the processor;
entering a voice recognition state in response to detecting the user having started speaking, extracting a user voice from the collected sound through the processor, determining a source language used by the user based on the extracted user voice, and determining a target language associated with the source language based on a preset language pair;
exiting the voice recognition state in response to detecting the user having stopped speaking for more than a preset delay duration, and converting the user voice extracted in the voice recognition state into a target voice of the target language through the processor; and
playing the target voice through the sound playback device, and returning to the step of detecting whether the user starts speaking based on the collected sound through the processor until the translation task ends.

2. The method of claim 1, wherein before the step of entering the voice recognition state in response to detecting the user having started speaking further comprises:
detecting whether a noise in the environment is greater than a preset noise based on the collected sound through the processor, and outputting prompt information for prompting the user the environment being unsuitable for translations if the noise is greater than the preset noise.

3. The method of claim 1, wherein the method further comprises:
setting at least two languages specified by a language specifying operation as the language pair through the processor, in response to the language specifying operation of the user.

4. The method of claim 1, wherein the translation apparatus further comprises a display screen electrically coupled to the processor, after the steps of entering the voice recognition state in response to detecting the user having started speaking and extracting the user voice from the collected sound through the processor further comprises:
converting the extracted user voice into a corresponding first text, and displaying the first text on the display screen;
the steps of exiting the voice recognition state in response to detecting the user having stopped speaking for more than the preset delay duration and converting the user voice extracted in the voice recognition state into the target voice of the target language through the processor specifically comprises:
exiting the voice recognition state in response to detecting the user having stopped speaking for more than the preset delay duration, translating the first text into a second text of the target language through the processor, and displaying the second text on the display screen; and
converting the second text into the target voice through a speech synthesis system.

5. The method of claim 1, wherein before the step of exiting the voice recognition state in response to detecting the user having stopped speaking for more than the preset delay duration further comprises:
exiting the voice recognition state in response to a translation instruction being triggered; and
adjusting the preset delay duration based on a time difference between a time of having detected the user having stopped speaking and a time of the translation instruction being triggered.

6. The method of claim 5, wherein the translation apparatus further comprises a motion sensor electrically coupled to the processor, the method further comprises:
triggering the translation instruction in the voice recognition state, when a motion amplitude of the translation apparatus detected through the motion sensors is greater than a preset amplitude or the translation apparatus is collided.

7. The method of claim 5, wherein the translation apparatus further comprises a storage electrically coupled to the processor, the step of determining the source language used by the user based on the extracted user voice further comprises:
extracting a voiceprint feature of the user in the user voice through the processor, and determining whether identifier information of a language corresponding to the voiceprint feature is stored in the storage;
determining a language corresponding to the identifier information as the source language, if the identifier information is stored in the storage; and
extracting a pronunciation feature of the user in the user voice, determining the source language based on the pronunciation feature, and storing a correspondence between the voiceprint feature of the user and the identifier information of the source language in the storage, if the identifier information is not stored in the storage.

8. The method of claim 7, wherein the step of adjusting the preset delay duration based on the time difference between the time of having detected the user having stopped speaking and the time of the translation instruction being triggered specifically comprises:
determining whether the preset delay duration corresponding to the voiceprint feature of the user having stopped speaking is stored in the storage;
adjusting the corresponding preset delay duration based on the time difference between the time of having detected the user having stopped speaking and the time of the translation instruction being triggered, if the corresponding preset delay duration is stored in the storage; and
setting the time difference as the corresponding preset delay duration, if the corresponding preset delay duration is not stored in the storage.

9. A translation apparatus, wherein the apparatus comprises:
an end point detecting module configured to collect a sound in an environment through the sound collecting device in response to a translation task being triggered, and detect whether a user starts speaking based on the collected sound;
a recognition module configured to enter a voice recognition state in response to detecting the user having started speaking, extract a user voice from the collected sound, determine a source language used by the user based on the extracted user voice, and determining a target language associated with the source language based on a preset language pair;
a tail point detecting module configured to detect whether the user has stopped speaking for more than a preset delay duration, and exit the voice recognition state in response to detecting the user having stopped speaking for more than the preset delay duration;
a translation and voice synthesizing module configured to convert the user voice extracted in the voice recognition state into a target voice of the target language through the processor; and
a playback module configured to play the target voice through the sound playback device, and trigger the end point detecting module to execute the step of detecting whether the user starts speaking based on the collected sound.

10. A translation apparatus, wherein the apparatus comprises a sound collecting device, a sound playback device, a storage, a processor, and a computer program stored in the storage and executable on the processor;
wherein, the sound collecting device, the sound playback device, and the storage are electrically coupled to the processor;
when the processor executes the computer program, the following steps are executed:
collecting a sound in an environment through the sound collecting device in response to a translation task being triggered, and detecting whether a user starts speaking based on the collected sound;
entering a voice recognition state in response to detecting the user having started speaking, extracting a user voice from the collected sound, determining a source language used by the user based on the extracted user voice, and determining a target language associated with the source language based on a preset language pair;
exiting the voice recognition state in response to detecting the user having stopped speaking for more than a preset delay duration, and converting the user voice extracted in the voice recognition state into a target voice of the target language; and
playing the target voice through the sound playback device, and returning to the step of detecting whether the user starts speaking based on the collected sound until the translation task ends.
